(19) United States
(12) Patent Application Publication
(10) Pub. No.: US 2013/0262549 A1
(43) Pub. Date: Oct. 3, 2013

(54) ARITHMETIC CIRCUIT AND ARITHMETIC METHOD

(71) Applicant: FUJITSU LIMITED, Kawasaki-shi (JP)

(72) Inventor: Kenichi KITAMURA, Kawasaki-shi (JP)

(21) Appl. No.: 13/736,328

(22) Filed: Jan. 8, 2013

(30) Foreign Application Priority Data
Mar. 30, 2012 (JP) 2012-080528

(51) Int. Cl. G06F 7/57

(52) U.S. Cl. CPC G06F 7/57
USPC 708/523

(57) ABSTRACT

An arithmetic circuit includes a circuit to output n-th multiples of a multiplicand, a circuit to output an XOR operation result that is a result of performing an exclusive logical sum operation between the multiplicand and a result of shifting the multiplicand to left by one bit, a circuit to output a first selection signal in response to a first portion of a multiplier, a circuit to output a second selection signal in response to a second portion of the multiplier, a circuit to select, in response to the first selection signal, one of the n-th multiples of the multiplicand and the XOR operation result, a circuit to select, in response to the second selection signal, one of the n-th multiples of the multiplicand and the XOR operation result, and a circuit to output a result of adding up the first partial product and the second partial product.

### CROSS-REFERENCE TO RELATED APPLICATIONS

The present application is based upon and claims the benefit of priority from the prior Japanese Patent Application No. 2012-080528 filed on Mar. 30, 2012, with the Japanese Patent Office, the entire contents of which axe incorporated herein by reference.

### FIELD

The disclosures herein relate to an arithmetic circuit and an arithmetic method.

### BACKGROUND

In recent years, encryption arithmetic has been used in an increasing number of instances due to heightened awareness for security, and, thus, encryption functions have been embedded in computers in an increasing number of cases. Encryption arithmetic often involves repeating complex computations, so that implementing an arithmetic unit as hardware is effective means to achieve high-speed operations. Since computation is complex, however, the cost of an arithmetic circuit and delay in the circuit become problems.

Carry-less multiplication is one type of encryption arithmetic. In normal multiplication, partial products, each of which is the product of the multiplicand and a corresponding digit of the multiplier, are obtained, and a carry propagates in the process of calculating the sum of the partial products. In carry-less multiplication, on the other hand, a carry is not allowed to propagate in the process of calculating the sum of the partial products. In such arithmetic, the sum without a carry in each digit contributes to the final product, so that the final product is obtained as the result of bitwise XOR operations between the partial products.

In normal binary multiplication, when processing each bit of the multiplier on a bit-by-bit basis, each partial product (i.e., the multiplicand, multiplied by 0 or 1) is obtained by calculating the product of the multiplicand and a bit (0 or 1) of interest of the multiplier, followed by calculating the sum of the partial products obtained with respect to all the bits. For the purpose of achieving high-speed multiplication, there is a computation method that processes two bits of multiplier at a time. In such a case, partial products are obtained by multiplying the multiplicand by 0, 1, 2, and 3 in response to 4 types of binary values 00, 01, 10, and 11, respectively, which appear in every two bits of the multiplier. In so doing, calculating multiplication by 0, multiplication by 1, and multiplication by 2 is easy, but a circuit for calculating multiplication by 3 will be complex, which gives rise to a problem. The Booth algorithm is generally used to obviate such a problem. This algorithm effectively obtains a third multiple as a fourth multiple plus the negative of a first multiple, without directly calculating the third multiple.

In carry-less multiplication also, it may be preferred to achieve high-speed multiplication by processing plural bits (e.g., two bits) of the multiplier at a time rather than processing one bit of the multiplier at a time.
[Patent Document 1] Japanese laid-open Patent Publication No. 10-326183.
[Patent Document 2] Japanese Laid-open Patent Publication No. 63-240219

### SUMMARY

According to an aspect of the embodiment, an arithmetic circuit includes a multiplicand store circuit to store a multiplicand, a multiplier store circuit to store a multiplier, an n-th-multiple calculating circuit to output n-th (n: integer) multiples of the multiplicand, an intermediate XOR calculating circuit to output an XOR operation result that is a result of performing an exclusive logical sum operation between the multiplicand and a result of shifting the multiplicand to left by one bit, a first decode circuit to output a first selection signal in response to a first portion of the stored multiplier, a second decode circuit to output a second selection signal in response to a second portion of the stored multiplier, a first partial product selecting circuit to select, in response to the first selection signal, one of the n-th multiples of the multiplicand output by the n th-multiple calculating circuit and the XOR operation result output by the intermediate XOR calculating circuit, a second partial product selecting circuit to select, in response to the second selection signal, one of the n-th multiples of the multiplicand output by the n-th-multiple calculating circuit and the XOR operation result output by the intermediate XOR calculating circuit, and an addition circuit to output a result of adding up the first partial product selected by the first partial product selecting circuit and the second partial product selected by the second partial product selecting circuit.

According to another aspect, an arithmetic method includes calculating n-th (n: integer) multiples of a multiplicand, calculating an XOR operation result that is a result of performing an exclusive logical sum operation between the multiplicand and a result of shifting the multiplicand to left by one bit, generating a first selection signal in response to a first portion of a multiplier, generating a second selection signal in response to a second portion of the multiplier, selecting, in response to the first selection signal, a first partial product that is a selected one of the n-th multiples of the multiplicand and the XOR operation result, selecting, in response to the second selection signal, a second partial product that is a selected one of the n-th multiples of the multiplicand and the XOR operation result, and outputting a result of adding up the first partial product and the second partial product.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a drawing illustrating an example of the configuration of a computer system;

FIGS. 2A and 2B are drawings illustrating comparison between an example of normal multiplication and an example of carry-less multiplication;

FIGS. 3A through 3D are drawings illustrating examples of calculation of partial products in carry-less multiplication when two bits of the multiplier are processed at a time;

FIG. 4 is a table illustrating which partial product is selected in response to the bit pattern of two bits of interest, in a multiplier;

FIG. 5 is a drawing illustrating an example of carry-less multiplication when two bits of the multiplier are processed at a time;

FIG. 6 is a drawing illustrating an example of an arithmetic circuit that performs carry-less multiplication by processing two bits of the multiplier at a time when the multiplier has a width of 4 bits;

FIG. 7 is a drawing illustrating an example of the configuration of an intermediate exclusive-OR calculating circuit;

FIG. 8 is a table illustrating which partial product is selected in response to the bit pattern of three bits, i.e., two bits of interest and the next lower bit;

FIG. 9 is a drawing 11 last rating an example of an arithmetic circuit that selectively performs either normal multiplication or carry-less multiplication by processing two bits of the multiplier at a time when the multiplier has a width of 4 bits;

FIG. 10 is a drawing illustrating an example of the truth table that shows relationships between inputs and outputs of a Booth decoder;

FIG. 11 is a drawing illustrating an example of the configuration of a CSA circuit;

FIG. 12 is a table illustrating which partial product is selected in response to the bit pattern of three bits of interest in a multiplier;

FIG. 13 is a drawing illustrating an example of an arithmetic circuit that performs carry-less multiplication by processing three bits of the multiplier at a time when the multiplier has a width of 4 bits;

FIG. 14 is a drawing illustrating an example of the configuration of an XOR2 calculating circuit;

FIG. 15 is a drawing illustrating an example of the configuration of an XOR3 calculating circuit;

FIG. 16 is a drawing illustrating an example of the configuration of an XOR4 calculating circuit;

FIG. 17 is a table illustrating which partial product is selected in response to the bit pattern of five bits, i.e., three bits of interest and the two next lower bits;

FIG. 18 is a drawing illustrating an example of an arithmetic circuit that selectively performs either normal multiplication or carry-less multiplication by processing three bits of the multiplier at a time when the multiplier has a width of 4 bits;

FIG. 19A is a drawing illustrating an example of the truth table that shows relationships between inputs and outputs of a decoder; and

FIG. 19B is a drawing illustrating an example of the truth table that shows relationships between inputs and outputs of a decoder.

### DESCRIPTION OF EMBODIMENTS

In the following, embodiments of the invention will be described with reference to the accompanying drawings.

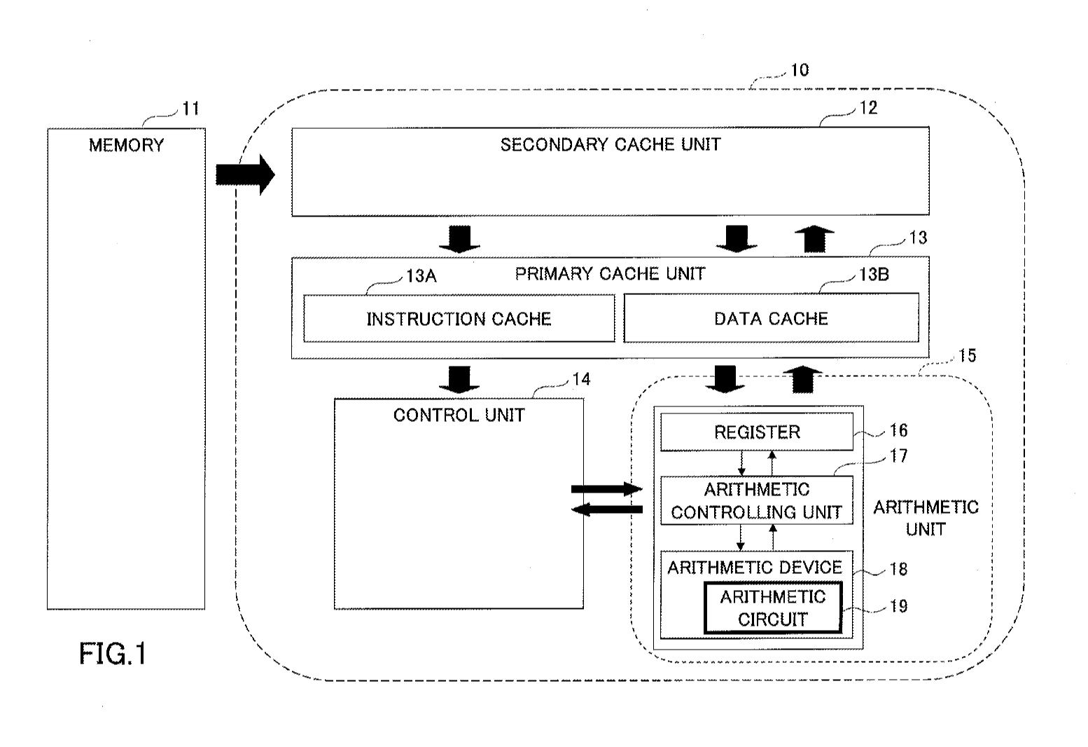

FIG. 1 is a drawing illustrating an example of the configuration of a computer system. The computer system illustrated in FIG. 1 includes a processor 10 serving as an arithmetic processing apparatus and a memory 11 serving as a main memory apparatus. The processor 10 includes a secondary cache unit 12, a primary cache unit 13, a control unit 24, and an arithmetic unit 15. The primary cache unit 13 includes an instruction cache 13A and a data cache 13B. The arithmetic unit 15 may be a processor core, and includes a register 16, an arithmetic controlling unit 17, and an arithmetic device 18. The arithmetic device 18 includes an arithmetic circuit 19. In FIG. 1 and the subsequent drawings, boundaries between functional blocks illustrated as boxes basically indicate functional boundaries, and may not correspond to separation in terms of physical positions, separation in terms of electrical signals, separation in terms of control logic, etc. Each functional block may be a hardware module that is physically separated, from other blocks, or may indicate a function in a hardware module in which this and other blocks are physically combined together. Each functional block may be a module that is logically separated from other blocks, or may indicate a function in a module in which this and other blocks are logically combined together.

In the processor 10, the cache memory system is implemented as having a multilayer structure in which the primary cache unit 13 and the secondary cache unit 12 are provided. Specifically, the secondary cache unit 13 that can be accessed faster than the main memory is situated between the primary cache unit 12 and the main memory (i.e., the memory 11). With this arrangement, the frequency of access to the main memory upon the occurrence of cache misses in the primary cache unit 13 is reduced, thereby lowering cache-miss penalty.

The control unit 14 issues an instruction fetch address and an instruction fetch request to a primary instruction cache 113A to fetch an instruction from this instruction fetch address. The control unit 14 decodes the fetched instruction, and controls the arithmetic unit 15 in accordance with the decode results to execute the fetched instruction. The arithmetic controlling unit 17 operates under the control of the control unit 14 to supply data to be processed from the register 16 to the arithmetic device 13 and to store processed data in the register 16 at a specified register location. Further, the arithmetic controlling unit 17 specifies the type of arithmetic performed by the arithmetic device 18. Moreover, the arithmetic controlling unit 17 specifies an address to be accessed to perform a load instruction or a store instruction with respect to this address in the primary cache unit 13. Data read from the specified address by the load instruction is stored in the register 16 at a specified register location. Data stored at a specified location in the register 16 is written to the specified address by the store instruction. The arithmetic circuit 19 included in the arithmetic device 18 performs carry-less multiplication.

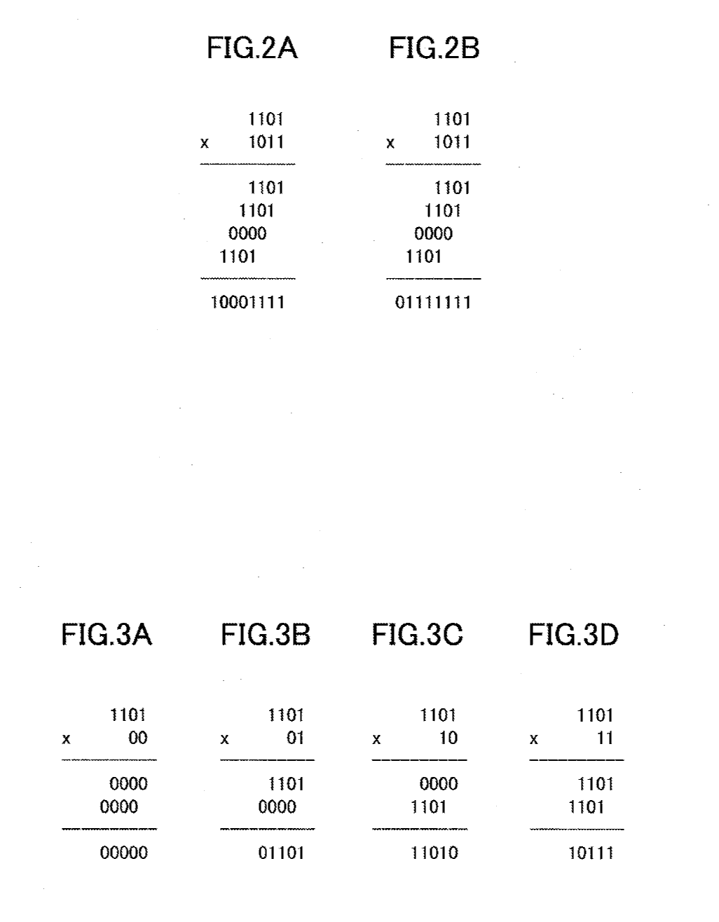

FIGS. 2A and 2B are drawings illustrating comparison between an example of normal multiplication and an example of carry-less multiplication. FIG. 2A illustrates multiplication of 4-bit numbers, which are the multiplicand “1101” and the multiplier “1011”. Each partial product (i.e., the multiplicand multiplied by 0 or 1) is obtained by calculating the product of the multiplicand and a bit (0 or 1) of interest of the multiplier, followed by calculating the sum of the four partial products obtained with respect to the four respective bits of the multiplier. In calculating the sum, a carry propagates. FIG. 2B illustrates carry-less multiplication of 4-bit numbers, which are the multiplicand “1101” and the multiplier “1011”. Each partial product (i.e., the multiplicand multiplied by 0 or 1) is obtained by calculating the product of the multiplicand and a bit (0 or 1) of interest or the multiplier, followed by calculating the sum of the four partial products obtained with respect to the four respective bits of the multiplier. In calculating the sum, a carry is not allowed to propagate. The result of the carry-less multiplication is equal to the result of an XOR (i.e., exclusive logical sum) between the four partial products. Both the arithmetic illustrated in FIG. 2A and the arithmetic illustrated in FIG. 2B are multiplication performed by processing one bit of the multiplier at a time.

FIGS. 3A through 3D are drawings illustrating examples of calculation of partial products in carry-less multiplication when two bits of the multiplier are processed at a time. The multiplicand is “1101”. FIG. 3A illustrates a case in which two bits of interest of the multiplier are “GO”. FIG. 3B illustrates a case in which two bits of interest of the multiplier are “01”. FIG. 3C illustrates a case in which two bits of interest of the multiplier are “10”. FIG. 3D illustrates a case in which two bits of interest of the multiplier are “11”.

In the case in which the multiplicand is “1101” and two bits of interest of the multiplier are “00” as illustrated in FIG. 3A, both the partial product for the first bit “0” and the partial product for the second bit “0” are “0000”, so that the result of an XOR operation between these partial products is “00000”. This XOR-operation result “00000” is the partial product between the multiplicand “1101” and the two bits “00” of the multiplier in carry-less multiplication in which two bits of the multiplier are processed at a time. This partial product is zero times the multiplicand “1.101”.

In the case in which the multiplicand is “1101” and two bits of interest of the multiplier are “01” as illustrated in FIG. 3B, the partial product for the first bit “I” is “1101”, and the partial product for the second bit “0” is “0000”, so that the result of an XOR operation between these partial products is “01101”. This XOR-operation result “01101” is the partial product between the multiplicand “1101” and the two bits “01” of the multiplier in carry-less multiplication in which two bits of the multiplier are processed at a time. This partial product is the first multiple of the multiplicand “1×01”.

In the case in which the multiplicand is “1101” and two bits of interest of the multiplier are “10” as illustrated in FIG. 38, the partial product for the first bit “0” is “0000”, and the partial product for the second bit “1” is “1101”, so that the result of an XOR operation between these partial products is “11010”. This XOR-operation result “11010” is the partial product between the multiplicand “1101” and the two bits “10” of the multiplier in carry-less multiplication, in which two bits of the multiplier are processed at a time. This partial product is the second multiple of the multiplicand “1101”.

In the case in which the multiplicand is “1101” and two bits of interest of the multiplier are “11” as illustrated in FIG. 3B, the partial product for the first bit “1” is “1101”, and the partial product for the second bit “1” is “1101”, so that the result of an XOR operation between these partial products is “10111”. This XOR-operation result “10111” is the partial product between the multiplicand “10111” and the two bits “11” of the multiplier in carry-less multiplication in which two bits of the multiplier are processed at a time. This partial product is the result of an XOR operation between the multiplicand “1101” and the result of shifting the multiplicand “1101” to left by one bit.

As can be understood from the above explanation, partial product candidates in carry-less multiplication in which two bits are processed at a time include zero times the multiplicand, the first multiple of the multiplicand, the second multiple of the multiplicand, and the result of an XOR operation between the multiplicand and the result of shifting the multiplicand to left by one bit. One of these four partial product candidates may be selected as the desired partial product in response to the bit pattern of the two bit of interest of the multiplier. It may be noted that zero times the multiplicand, the first multiple of the multiplicand, and the second multiple of the multiplicand are an n-th multiple of the multiplicand (n: natural number).

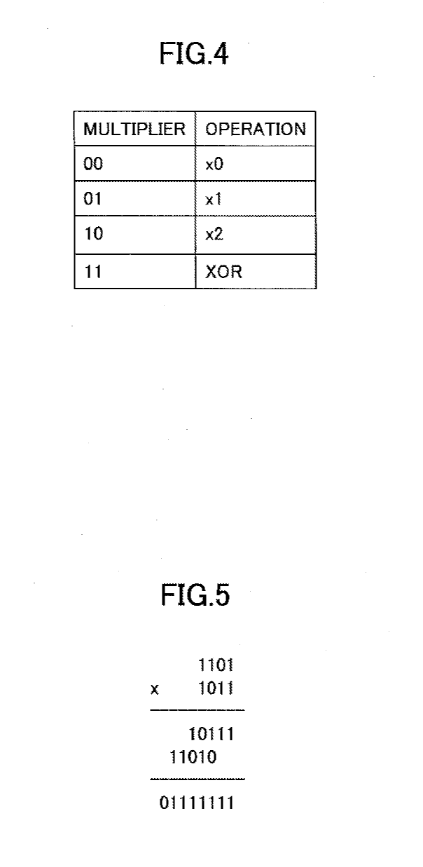

FIG. 4 is a table illustrating which one of the partial products is selected in response to the bit pattern of two bits of interest in a multiplier. The left-hand side column of the table lists the bit patterns of two bits of a multiplier, i.e., “00”, “01”, “10”, and “11”. The right-hand side column of the table lists the partial products that are selected with respect to the respective bit patterns. Here, “x0” denotes zero times the multiplicand, “x1” the first multiple, “x2” the second multiple, and “XOR” the result of an XOR operation between the multiplicand and the result of shifting the multiplicand to left by one bit. When the two bits of interest of the multiplier is “10”, for example, this table indicates that the second, multiple (“x2”) is selected as the partial product.

FIG. 5 is a drawing illustrating an example of carry-less multiplication, when two bits of the multiplier are processed at a time. As in FIGS. 2A and 28, multiplication of 4-bit numbers, which are the multiplicand “1101” and the multiplier “1011”, are illustrated in FIG. 5. According to the table illustrated in FIG. 4, the result “10111” of an XOR operation between the multiplicand and the result of shifting the multiplicand to left by one bit is obtained as the partial product for the two least significant bits “11” of the multiplier. Further, according to the table illustrated in FIG. 4, the second multiple “11010” of the multiplicand is obtained as the partial product for the two most significant bits “10” of the multiplier. An XOR operation is then performed between these two partial products, and the result of the XOR operation, i.e., “01111111”, is obtained as the result of carry-leas multiplication.

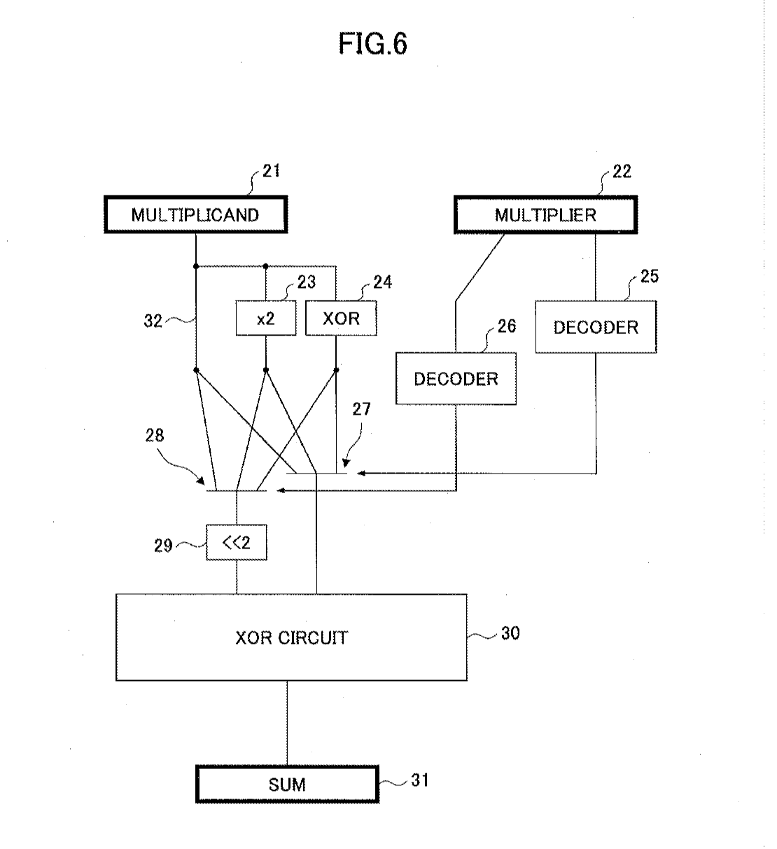

FIG. 6 is a drawing illustrating an example of an arithmetic circuit that performs carry-less multiplication by processing two bits of the multiplier at a time when the multiplier has a width of 4 bits. The arithmetic circuit illustrated in FIG. 6 includes a multiplicand latch circuit 21, a multiplier latch circuit 22, a second-multiple calculating circuit 23, an intermediate exclusive-OR calculating circuit 24, a first decoder 25, a second decoder 26, a first partial product selecting circuit 27, a second partial product selecting circuit 28, a bit shift circuit 29, and an XOR circuit 30. Further, an arithmetic result latch circuit 31 may be provided to store the result of an arithmetic performed by the XOR circuit 30. FIG. 6 illustrates the configuration for a 4-bit multiplier. This is only a non-limiting example, and the bit width of the multiplier is not limited to any particular number. When the bit width of the multiplier is M (even number), M/2 decoders may be provided in place of the two decoders 25 and 26. Further, M/2 partial product selecting circuits may be provided in place of the partial product selecting circuits 27 and 28. Even in such a case, the operations of each decoder and each partial product selecting circuit are the same as or similar to the operations of the decoders 25 and 26 and the partial product selecting circuits 27 and 28. The wider the bit width of the multiplier is, the larger the number of bits input into the XOR circuit 30 is. Regardless of this, the fact that an XOR operation is performed in the XOR circuit 30 remains the same.

The multiplicand latch circuit 21 may be a register to store a multiplicand. The multiplier latch circuit 22 may be a register to store a multiplier. The second-multiple calculating circuit 23 produces the second multiple of the multiplicand. It may be noted that a signal line 32 serves as a first-multiple calculating circuit that produces the first multiple of the multiplicand. The zero-times-multiplicand calculating circuit that produces zero times the multiplicand is not explicitly illustrated. In this regard, the partial product selecting circuits 27 and 28 have the function to select and output the fixed value “0”. With this arrangement, the partial product selecting circuits 27 and 28 output “0” when the respective decoders 25 and 26 supply a selection signal indicating the selection of zero times the multiplicand. The circuit portion that provides the fixed value “0”, the signal line 32 serving as the first-multiple calculating circuit, and the second-multiple calculating circuit 23 may be collectively regarded as constituting an n-th-multiple calculating circuit that produces the n-th multiple of the multiplicand (n: integer).

The intermediate exclusive-OR calculating circuit 24 produces the XOR operation result that is obtained by performing an exclusive logical sum operation between the multiplicand and the result of shifting the multiplicand to left by one bit. The first decoder 25 produces a first election signal in response to a first portion (e.g., the two least significant bits) of the multiplier stored in the multiplier latch circuit 22. The second decoder 26 produces a second selection signal in response to a second portion (e.g., the two most significant bits) of the multiplier stored in the multiplier latch circuit 22. Specifically, the first decoder 25 and the second decoder 26 produce selection signals responsive to the respective two bits of the multiplier, i.e., the two least significant bits and the two most significant bits, respectively, in accordance with the table illustrated in FIG. 4. Namely, each of the first decoder 25 and the second decoder 26 produces a selection signal comprised of at least two bits that identifies one of zero times the multiplicand, the first multiple of the multiplicand, the second multiple of the multiplicand, and the result of an XOR operation between the multiplicand and the result of shifting the multiplicand to left by one bit.

In response to the first selection signal, the first partial product selecting circuit 27 selects one of the n-th multiples of the multiplicand produced by the n-th-multiple calculating circuit and the XOR operation result produced by the intermediate exclusive-OR calculating circuit 24. Specifically, in response to the first selection signal, the first partial product selecting circuit 27 selects the fixed value “0”, the first multiple of the multiplicand from the signal line 32, the second multiple of the multiplicand from the second-multiple calculating circuit 23, or the XOR operation result from the intermediate exclusive-OR calculating circuit 24.

In response to the second selection signal, the second partial product selecting circuit 28 selects one of the n-th multiples of the multiplicand produced by the n-th-multiple calculating circuit and the XOR operation result produced by the intermediate exclusive-OR calculating circuit 24. Specifically, in response to the second selection signal, the second partial product selecting circuit 28 selects the fixed value “0”, the first multiple of the multiplicand from the signal line 32, the second multiple of the multiplicand from the second-multiple calculating circuit 23, or the XOR operation result from the intermediate exclusive-OR calculating circuit 24.

The first partial product supplied by the first partial product selecting circuit 27 and the second partial product supplied by the second partial product selecting circuit 28 are supplied to the XOR circuit 30. In so doing, the second partial product is shifted to left by two bits by the bit shift circuit 29 for provision to the XOR circuit 30 in order to take into account a difference in bit positions between the first partial product and the second partial product.

The XOR circuit 30 serves to produce an addition result that is obtained by adding up the first partial product supplied by the first partial product selecting circuit 27 and the second partial product supplied by the second partial product selecting circuit 28. Specifically, no carry is allowed to propagate in this addition operation, so that the addition result is equal to the result of an XOR operation. The XOR circuit 30 may be a circuit that is designed to perforin an XOR operation only, or may be an adder circuit in which the path for carry propagation is blocked so as not to allow carry propagation. A carry save adder circuit may be used as such an adder circuit.

When the XOR circuit 30 is an XOR circuit designed to perform an XOR operation only, the result of an XOR operation between two partial products as illustrated in FIG. 5 may be obtained.

Namely, the XOR circuit may be provided for the overlapping portion (i.e., three overlapping bits) between the first partial, product and the second, partial product, and may produce an XOR operation result for the overlapping portion between the first partial product and the second partial product. If the bit width of the multiplier is M (even number), M/2 partial products are subjected to an XOR operation. In such a case, an XOR operation result is obtained for the overlapping portion between the first partial product and the second partial product, and, then, an XOR operation is performed for the overlapping portion between this XOR operation result and another partial product such as the third partial product.

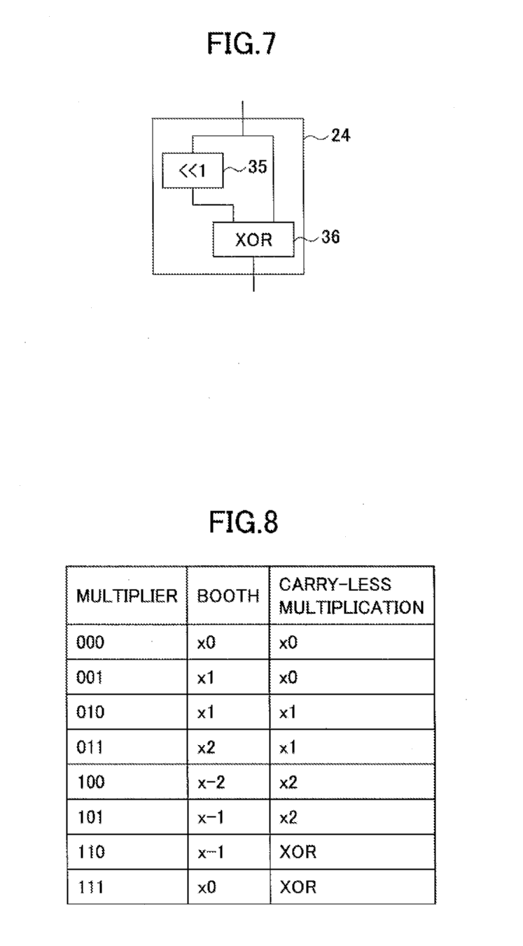

FIG. 7 is a drawing illustrating an example of the configuration of the intermediate exclusive-OR calculating circuit 24. The intermediate exclusive-OR calculating circuit 24 includes a bit shift circuit 35 and an XOR circuit 36. The bit shift circuit 35 outputs a result obtained by shifting the multiplicand to left by one bit. The XOR circuit 36 produces the result of an XOR operation between the multiplicand and the output of the bit shift circuit 35, thereby obtaining an exclusive logical sum between the multiplicand and the result of shifting the multiplicand to left by one bit.

In the following, a description will be given of an arithmetic circuit that is capable of selectively performing one of normal multiplication and carry-less multiplication. As was previously described, with respect to normal binary multiplication, there is a computation method that processes two bits of multiplier at a time for the purpose of achieving high-speed multiplication. In such a case, partial products are obtained by multiplying the multiplicand by 0, 1, 2, and 3 in response to 4 types of binary values 00, 01, 10, and 11, respectively, which appear in every two bits of the multiplier. In so doing, calculating multiplication by 0, multiplication by 1, and multiplication by 2 is easy, but a circuit for calculating multiplication by 3 will be complex, which gives rise to a problem. The Booth algorithm is generally used to obviate such a problem. This algorithm effectively obtains a third multiple without directly calculating the third multiple.

Specifically, the Booth algorithm utilizes the fact that the third multiple is equal to the forth multiple plus the negative of the first multiple for the purpose of calculating the third multiple. Namely, the object of obtaining a final result of adding the third multiple to a given number is achieved by adding the negative of the first multiple with respect to given two bits of the multiplier and then adding the first multiple with respect to the next two bits of the multiplier. This is because the first multiple for the next two bits of the multiplier is the fourth multiple with respect to the preceding two bits. In this manner, the final result in which the negative of the first multiple and the fourth multiple are added is obtained, thereby achieving calculation equivalent to the addition of the third multiple.

It may be noted that, given two bits of interest, a multiple that is to be added may need to be determined in response to these two bits, and, further, a check may need to be made as to whether the first multiple needs to be added in consideration of the preceding two bits. In order to determine whether the first multiple is to be added for the preceding two bits, the bit next lower than the bit of interest is checked. The fact that this checked bit is “1” indicates that the first multiple is to be added for the preceding two bits. Because of this, when the second multiple is added upon processing the preceding two bits (i.e., when the preceding two bits are “10”), the second multiple is calculated as the fourth multiple plus the negative of the second multiple since the bit next lower than the next two bits is “1”. In this manner, three bits only, i.e., two bits of interest and the next lower bit, are referred to in order to select a correct multiple that takes into account the multiple for the preceding two bits and the multiple for the two bits of interest.

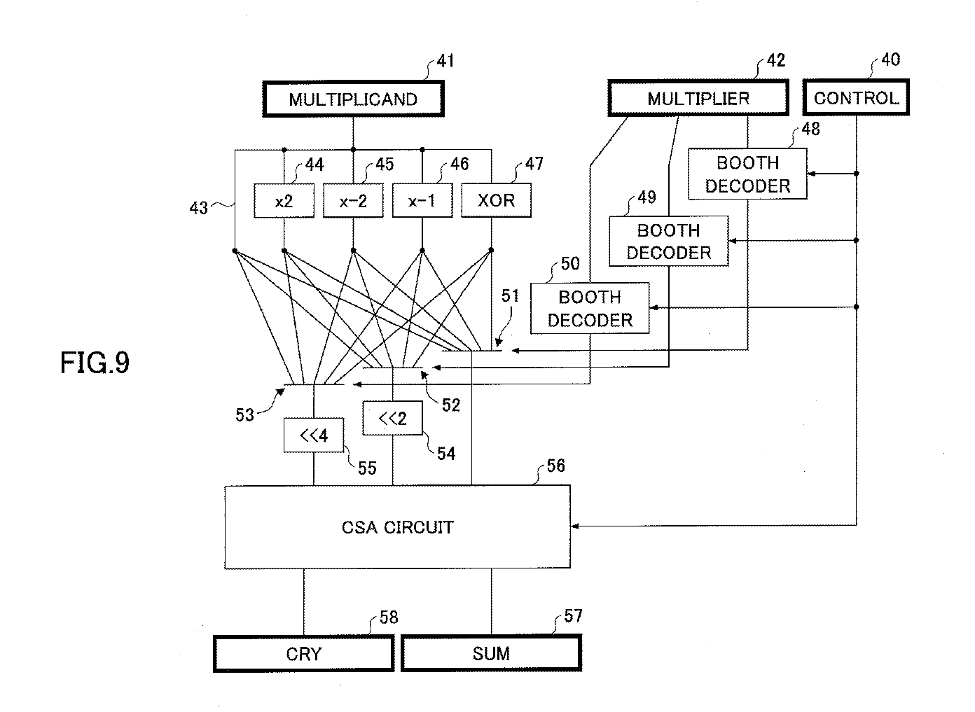

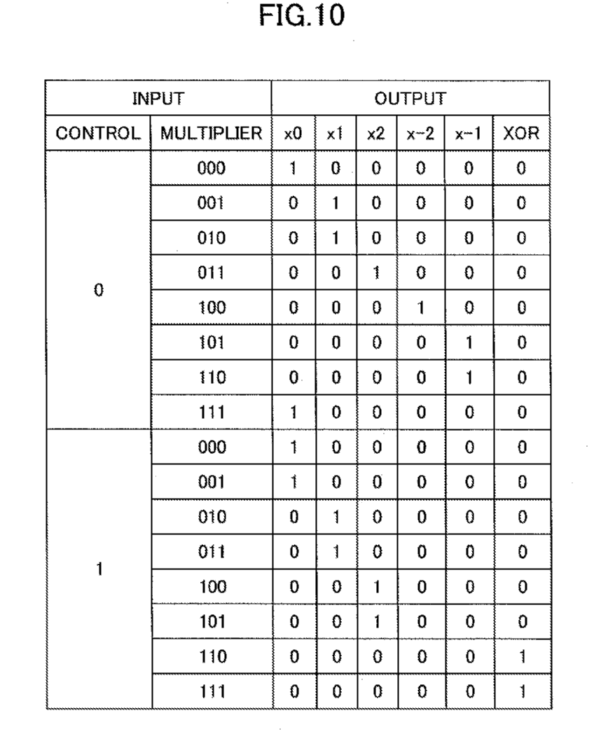

FIG. 8 is a table illustrating which one of the partial products is selected in response to the bit pattern of three bits, i.e., two bits of interest and the next lower bit. In order to cope with both normal multiplication based on the Booth algorithm and carry-less multiplication, both a partial product to foe selected according to the Booth algorithm and a partial product to be selected for carry-less multiplication are defined with respect to the bit patterns of the three bits. The left-hand side column of the table lists the bit patterns of three bits of a multiplier, i.e., “000” through “1111”. The rightmost bit is the next lower bit, and the two upper-order bits are the two bits of interest.

The middle column of the table lists the partial products that are selected with respect to the respective bit patterns for normal multiplication based on the Booth algorithm. The notations “x−1” and “x2” represent the negative of the first multiple of the multiplicand and the negative of the second multiple of the multiplicand, respectively. When the three bits of the multiplier are “101”, for example, the second multiple is to be added for the two bits “10” of interest. Since the second multiple is calculated as the fourth multiple plus the negative of the second multiple, the negative of the second multiple is selected for the two bits “10” of interest. The fact that the next lower bit is “1” indicates that the first multiple is to be added for the preceding two bits. As a result, the negative of the first multiple (x−1), i.e., the negative of the second multiple plus the first multiple, is selected as the partial product when the three bits of the multiplier are “101”.

The right-hand side column of the table lists the partial products that are selected with respect to the respective bit patterns for carry-less multiplication. Notations are the same as those used in FIG. 4. As can be understood from the previous description, it suffices to focus attention on the two bits of interest of the multiplier in carry-less multiplication, and there is no need to check the next lower bit. Accordingly, a partial product is selected only in response to the value of the two upper-order bits regardless of the value of the least significant bit in the three bits of the multiplier. Namely, the partial product that is selected for carry-less multiplication upon focusing attention on the two upper-order bits of the multiplier in the table illustrated in FIG. 8 is the same as the partial product that is selected for the same value of the two bits of the multiplier illustrated in FIG. 4.

FIG. 9 is a drawing illustrating an example of an arithmetic circuit that selectively performs either normal multiplication or carry-less multiplication by processing two bits of the multiplier at a time when the multiplier has a width of 4 bits. The arithmetic circuit illustrated in FIG. 9 includes a control-value latch circuit 40, a multiplicand latch circuit 41, a multiplier latch circuit 42, a signal line 43, a second-multiple calculating circuit 44, a negative-second-multiple calculating circuit 45, a negative-first-multiple calculating circuit 46, an intermediate exclusive-OR calculating circuit 47, and Booth decoders 43 through 50. The arithmetic circuit further includes partial product selecting circuits 51 through 53, a bit shift circuit 54, a bit shift circuit 55, and a CSA (carry save adder) circuit 56. Further, an addition result latch circuit 57 and a carry latch circuit 58 may be provided to store the results of an arithmetic performed by the CSA circuit 56. FIG. 9 illustrates the configuration for a 4-bit multiplier. This is only a non-limiting example, and the bit width of the multiplier is not limited to any particular number. When the bit width of the multiplier is M (even number), M/2+1 decoders may be provided in place of the three decoders 48 through 50. Further, M/2+1 partial product selecting circuits may be provided in place of the partial product selecting circuits 51 through 53. Even in such a case, the operations of each decoder and each partial product selecting circuit are the same as or similar to the operations of the decoders 48 through 50 and the partial product selecting circuits 51 through 53. The wider the bit width of the multiplier is, the larger the number of bits input into the CSA circuit 56 is. Regardless of this, the fact that carry save addition is performed in the CSA circuit 56 remains the same.

The control-value latch circuit 40 stores a control value indicative of either carry-less multiplication or normal multiplication based on the Booth algorithm. This stored value assumes “0” to indicate normal multiplication, and assumes “1” to indicate carry-less multiplication, for example.

The multiplicand latch circuit 41 may be a register to store a multiplicand. The multiplier latch circuit 42 may be a register to store a multiplier. The signal line 43 serves as a first-multiple calculating circuit that produces the first multiple of the multiplicand. The second-multiple calculating circuit 44 produces the second multiple of the multiplicand. The negative-second-multiple calculating circuit 45 produces the negative of the second multiple of the multiplicand. The negative-first-multiple calculating circuit 46 produces the negative of the first multiple of the multiplicand. The zero-times-multiplicand calculating circuit that produces zero times the multiplicand is not explicitly illustrated. In this regard, the partial product selecting circuits 51 through 53 have the function to select and output the fixed value “0”. With this arrangement, the partial product selecting circuits 51 through 53 output “0” when the respective decoders 48 through 50 supply a selection signal indicating the selection of zero times the multiplicand. The circuit portion that provides the fixed value “0”, the signal line 45 serving as the first-multiple calculating circuit, the second-multiple calculating circuit 44, the negative-second-multiple calculating circuit 45, and the negative-first-multiple calculating circuit 46 may be collectively regarded as constituting an n-th-multiple calculating circuit that produces the n-th multiple of the multiplicand n: integer).

The intermediate exclusive-OR calculating circuit 47 produces the XOR operation result that is obtained by performing an exclusive logical sum operation between the multiplicand and the result of shifting the multiplicand to left by one bit. The Booth decoder 48 produces a first election signal in response to a first portion (e.g., the two least significant bits and the imaginary next lower bit “0”) of the multiplier stored in the multiplier latch circuit 42. The Booth decoder 49 produces a second selection signal in response to a second, portion (e.g., the two most significant bits and the next lower bit) of the multiplier stored in the multiplier latch circuit 42. The Booth decoder 50 produces a third selection signal in response to a third portion (e.g., two imaginary bits “00” situated immediately above the two most significant bits and the next lower bit) of the multiplier stored in the multiplier latch circuit 42. Specifically, the Booth decoders 48 through 50 produce selection signals corresponding to the respective three-bit portions of the multiplier according to the table illustrated in FIG. 8. Namely, each of the Booth decoders 48 through 50 produces a selection signal that identifies one of zero times the multiplicand, the first multiple of the multiplicand, the second multiple of the multiplicand, the negative of the second multiple of the multiplicand, the negative of the first multiple of the multiplicand, and the result of an XOR operation between the multiplicand and the result of shifting the multiplicand to left by one bit.

FIG. 10 is a drawing illustrating an example of the truth table that shows relationships between inputs and outputs of a Booth decoder. Each of the Booth decoders 48 through 50 illustrated in FIG. 9 may produce a decode signal for selecting an arithmetic in accordance with the truth table illustrated in FIG. 10. When the control value stored in the control-value latch circuit 40 is “0” indicative of normal multiplication, a selection signal for selecting the second multiple (x2) is output in response to the three bits of the multiplier being “011”, for example. When the control value stored in the control-value latch circuit 40 is “0” indicative of normal multiplication, a selection signal for selecting the negative of the first multiple (x−1) is output in response to the three bits of the multiplier being “110”, for example. When the control value stored in the control-value latch circuit 40 is “1” indicative of carry-less multiplication, a selection signal for selecting the first multiple (x1) is output in response to the three bits of the multiplier being “011”, for example. When the control value stored in the control-value latch circuit 40 is “1” indicative of carry-less multiplication, a selection signal for selecting the result of an XOR operation between the multiplicand and the result of shifting the multiplicand to loft by one bit is output in response to the three bits of the multiplier being “110”, for example.

By referring to FIG. 9 again, in response to the first selection signal, the partial product selecting circuit 51 selects one of the n-th multiples of the multiplicand produced by the n-th-multiple calculating circuit and the XOR operation result produced by the intermediate exclusive-OR calculating circuit 47. Specifically, the partial product selecting circuit 51 selects, in response to the first selection signal, one of zero times the multiplicand, the first multiple of the multiplicand, the second multiple of the multiplicand, the negative of the second multiple of the multiplicand, the negative of the first multiple of the multiplicand, and the result of an XOR operation between the multiplicand and the result of shifting the multiplicand to left by one bit. The partial product selecting circuit 52 also performs a similar selection operation in response to the second selection signal. The partial product selecting circuit 53 also performs a similar selection operation in response to the third selection signal.

The three partial products output by the partial product selecting circuits 51 through 53 are supplied to the CSA circuit 56. In so doing, the partial product from the partial product selecting circuit 52 is shifted to left by two bits by the bit shift circuit 54 for provision to the CSA circuit 56 in order to take into account a difference in bit positions. Further, the partial product from the partial product selecting circuit 53 is shifted to left by four bits by the bit shift circuit 55 for provision to the CSA circuit 56 in order to take into account a difference in bit positions.

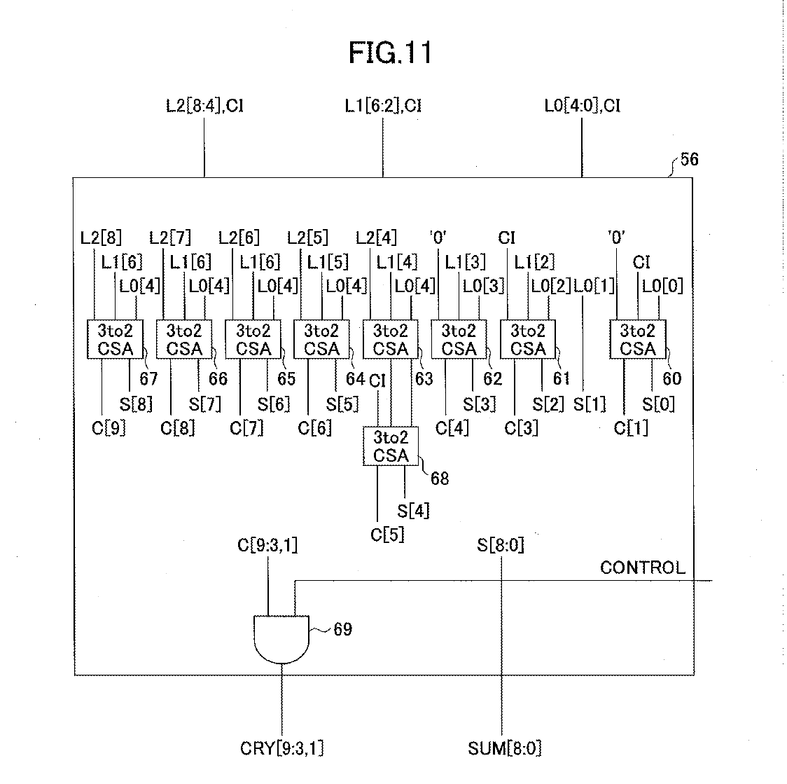

FIG. 11 is a drawing illustrating an example of the configuration of the CSA circuit 56. The CSA circuit 56 includes three-input and two-output CSA circuits 60 through 68 and an AND gate 69. L0[4:0] denotes a 5-bit partial, product from the partial product selecting circuit 51. L1[6:2] denotes a 5-bit partial product from the partial product selecting circuit 52. L2[8:4] denotes a 5-bit partial product from the partial product selecting circuit 53. The notation “[x:y]” means y-th through x-th bit as counted, from the least significant bit in terms of bits positions aligned by the bit shift circuits.

An addition result SUM[8:0] is data S[8:0], which includes addition results S[0] and S[2] through S[8] output, from the CSA circuits to through 62, the CSA circuit 68, and the CSA circuits 64 through 67, and also includes S[1] that is the same as L0[1]. Carries CRY[9:3,1] are data C[9:3,1], which includes carries C[1] and C[3] through C[9] output from the CSA circuits 60 through 62, the CSA circuit 68, and the CSA circuits 64 through 67.

The CSA circuit 56 is an adder circuit that produces the addition result SUM[8:0] obtained by adding up the partial products selected by the partial product selecting circuits 51 through 53, respectively. Specifically, no carry is allowed to propagate in this addition operation. The three-input and two-output CSA circuits 60 through 68 are provided for the overlapping portion between the partial products so as to obtain a result of an addition operation performed with respect to the overlapping portion between the partial products. In such a case, an addition operation result may be obtained for the overlapping portion between the first partial product and the second partial product, and, then, an addition operation, may be performed for the overlapping portion between this addition operation result and another partial product such as the third partial product. The AND gate 69 serves as a mask circuit that blocks the propagation of carries that are created as a result of an addition operation performed with respect to the overlapping portion between the partial products. The AND gate 69 may allow the carries to propagate when the control value stored in the control-value latch circuit 40 indicates normal multiplication, and may not allow the carries to propagate when the control value stored in the control-value latch circuit 40 indicates carry-less multiplication.

The description provided above has been directed to a case in which two bits of the multiplier are processed at a time. The number of bits processed at a time is not limited, to two, and may be three or more. In the following, a description will, be given of an arithmetic circuit that processes three bits of the multiplier at a time.

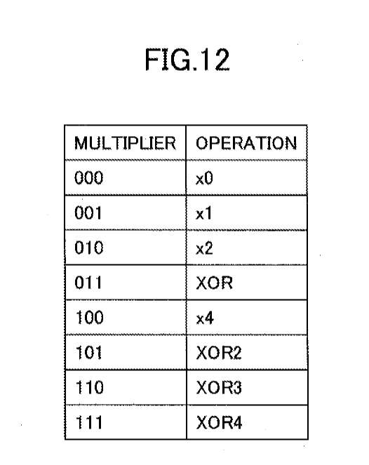

FIG. 12 is a table illustrating which one of the partial products is selected in response to the bit pattern of three bits of interest in a multiplier. The left-hand side column of the table lists the bit patterns of three bits of a multiplier, i.e., “000” through “1111”. The right-hand side column of the table lists the partial products that are selected with respect to the respective bit patterns. Here, “x0” denotes zero times the multiplicand, “x1” the first multiple, “x2” the second multiple, and “x4” the fourth multiple. “XOR” denotes the result of an XOR operation performed between the multiplicand and the result of shifting the multiplicand to left by one bit. In the following, this operation is referred to as XOR1. “XOR2” denotes the result of an XOR operation performed between the multiplicand and the result of shifting the multiplicand to left by two bits. In the following, this operation is referred to as XOR2. “XOR3” denotes the result of an XOR operation performed between the result of shifting the multiplicand to left by two bits and the result of shifting the multiplicand to left by one bit. In the following, this operation is referred to as XOR3. “XOR4” denotes the result of an XOR operation performed between the result of shifting the multiplicand to left by two bits, the result of shifting the multiplicand to left by one bit, and the multiplicand. In the following, this operation is referred to as XOR4. When the three bits of interest of the multiplier is “010”, for example, this table indicates that the second multiple “x2”) is selected as the partial product.

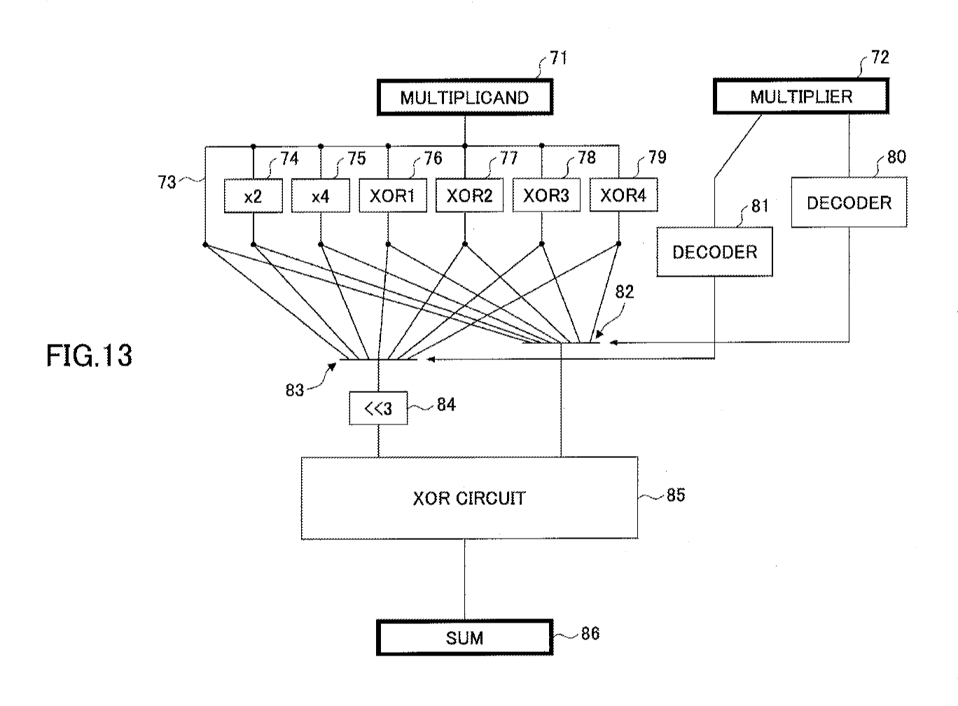

FIG. 13 is a drawing illustrating an example of an arithmetic circuit that performs carry-less multiplication by processing three bits of the multiplier at a time when the multiplier has a width of 4 bits. The arithmetic circuit illustrated in FIG. 13 includes a multiplicand latch circuit 71, a multiplier latch circuit 72, a signal line 73, a second-multiple calculating circuit 74, a fourth-multiple calculating circuit 75, an XOR1 calculating circuit 76, an XOR2 calculating circuit 77, an XOR3 calculating circuit 78, an XOR4 calculating circuit 79, a decoder 80, and a decoder 81. The arithmetic circuit further includes a partial product selecting circuit 62, a partial product selecting circuit 83, a bit shift circuit 84, and an XOR circuit 85. Further, an arithmetic result latch circuit 86 may be provided to store the result of an arithmetic performed by the XOR circuit 35. FIG. 13 illustrates the configuration for a 4-bit multiplier. This is only a non-limiting example, and the bit width of the multiplier is not limited to any particular number. Irrespective of the number of bits in the multiplier, the operations of each decoder and each partial product selecting circuit are the same as or similar to the operations of the decoders and the partial product selecting circuits previously described. The wider the bit width of the multiplier is, the larger the number of bits input into the XOR circuit 85 is. Regardless of this, the fact that an XOR operation is performed in the XOR circuit 85 remains the same.

While the decoders 25 and 26 of the arithmetic circuit illustrated in FIG. 6 output selection signals according to the table illustrated in FIG. 4, the decoders 80 and 81 of the arithmetic circuit illustrated in FIG. 13 output selection signals according to the table illustrated in FIG. 12. Further, in the arithmetic circuit illustrated in FIG. 6, the partial product selecting circuits 27 and 28 select one of zero times the multiplicand, the first multiple, the second multiple, and the XOR1 operation result. On the other hand, in the arithmetic circuit illustrated in FIG. 13, the partial product selecting circuits 82 and 83 select one of zero times the multiplicand, the first multiple, the second multiple, the fourth multiple, the XOR1 operation result, the XOR2 operation result, the XOR3 operation result, and the XOR4 operation result. Moreover, while the bit shift circuit 20 in the arithmetic circuit illustrated in FIG. 6 performs a two-bit left shift, the bit shift circuit 84 in the arithmetic circuit illustrated in FIG. 13 performs a three-bit left shift. With respect to other than what is noted above, the arithmetic circuit illustrated in FIG. 6 and the arithmetic circuit illustrated in FIG. 13 are basically the same as or similar to each other, and a detailed description thereof will be omitted.

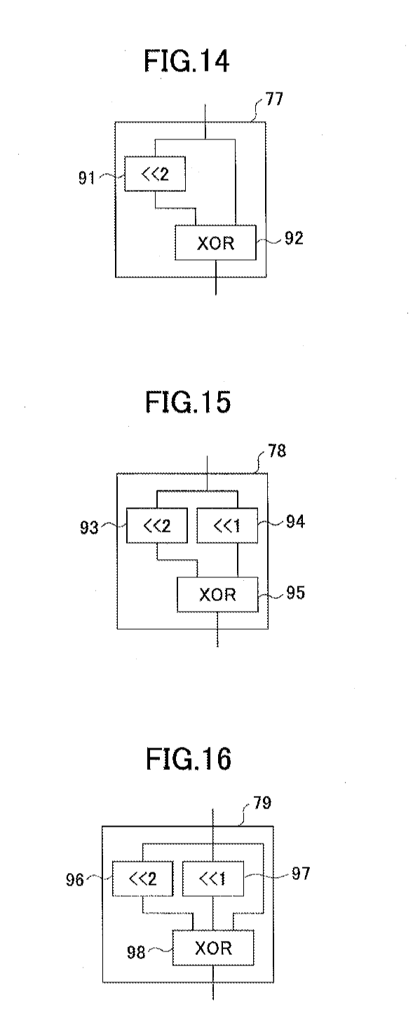

FIG. 14 is a drawing illustrating an example of the configuration of the XOR2 calculating circuit 77. The XOR2 calculating circuit 77 includes a bit shift circuit 91 and an XOR circuit 92. The bit shift circuit 91 outputs a result obtained by shifting the multiplicand to left by two bits. The XOR circuit 92 produces the result of an XOR operation between the multiplicand and the output of the bit shift circuit 91, thereby obtaining an exclusive logical sum between the multiplicand and the result of shifting the multiplicand to left by two bits. The XOR1 calculating circuit 76 illustrated in FIG. 13 may have the same or similar circuit configuration as the intermediate exclusive-OR calculating circuit 24 illustrated in FIG. 7.

FIG. 15 is a drawing illustrating an example of the configuration of the XOR3 calculating circuit 78. The XOR3 calculating circuit 78 includes bit shift circuits 93 and 94 and an XOR circuit 93. The bit shift circuit 93 outputs a result obtained by shifting the multiplicand to left by two bits. The bit shift circuit 94 outputs a result obtained, by shifting the multiplicand to left by one bit. The XOR circuit 95 produces the result of an XOR operation between the output of the bit shift circuit 93 and the output of the bit shift circuit 94, thereby obtaining an exclusive logical sum between the result of shifting the multiplicand to left by two bits and the result of shifting the multiplicand to left by one bit.

FIG. 16 is a drawing illustrating an example of the configuration of the XOR4 calculating circuit 79. The XOR4 calculating circuit 79 includes bit shift circuits 96 and 97 and an XOR circuit 98. The bit shift circuit 96 outputs a result obtained, by shifting the multiplicand to left by two bits. The bit shift circuit 97 outputs a result obtained by shifting the multiplicand to left by one bit. The XOR circuit 33 produces the result of an XOR operation between the output of the bit shift circuit 96, the output of the bit shift circuit 57, and the multiplicand, thereby obtaining an exclusive logical surfs, between the result of shifting the multiplicand to left by two bits, the result of shifting the multiplicand to left by one bit, and the multiplicand.

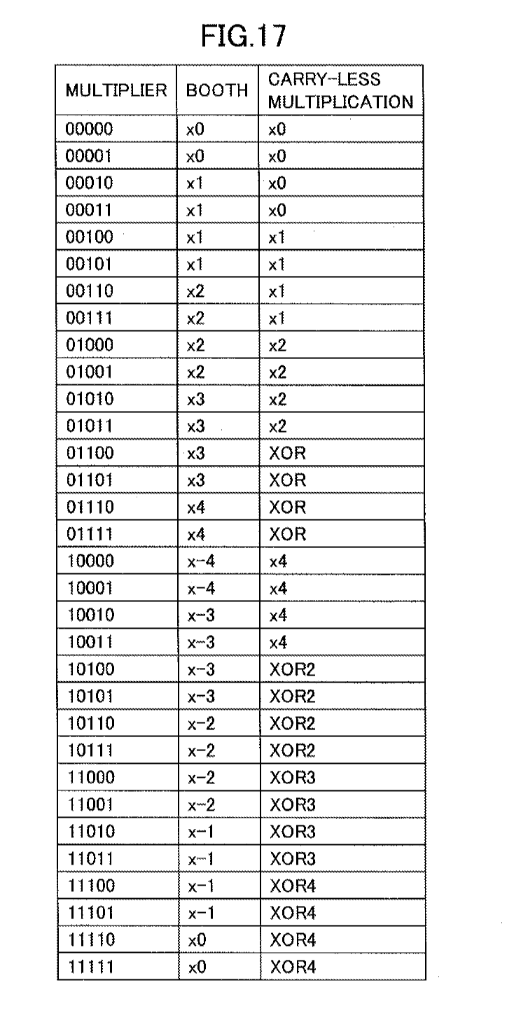

FIG. 17 is a table illustrating which one of the partial products is selected in response to the bit pattern of five bits, i.e., three bits of interest and the two next lower bits. In order to cope with both normal multiplication and carry-less multiplication, both a partial product to be selected for normal multiplication and a partial product to be selected for carry-less multiplication are defined with respect to the bit patterns of the five bits. The left-hand side column of the table lists the bit patterns of five bits of a multiplier, i.e., “00000” through “111111”. The two rightmost bits are the two bits next lower than the three bits of interest, and the three upper-order bits are the three bits of interest.

The middle column of the table lists the partial products that are selected with respect to the respective bit patterns for normal multiplication. The notations “x−1”, “x−2”, and so on represent the negative of the first multiple of the multiplicand, the negative of the second, multiple of the multiplicand, and so on.

The right-hand side column of the table lists the partial products that are selected with respect to the respective bit patterns for carry-less multiplication. Notations are the same as those used in FIG. 12. As can be understood from the previous description, it suffices to focus attention on the three bits of interest of the multiplier in carry-less multiplication, and there is no need to check the two nest lower bits. Accordingly, a partial product is selected only in response to the value of the three upper-order bits regardless of the value of the two least significant bits in the five bits of the multiplier. Namely, the partial product that is selected for carry-less multiplication upon focusing attention on the three upper-order bits of the multiplier in the table illustrated in FIG. 17 is the same as the partial product that is selected for the same value of the three bits of the multiplier illustrated in FIG. 12.

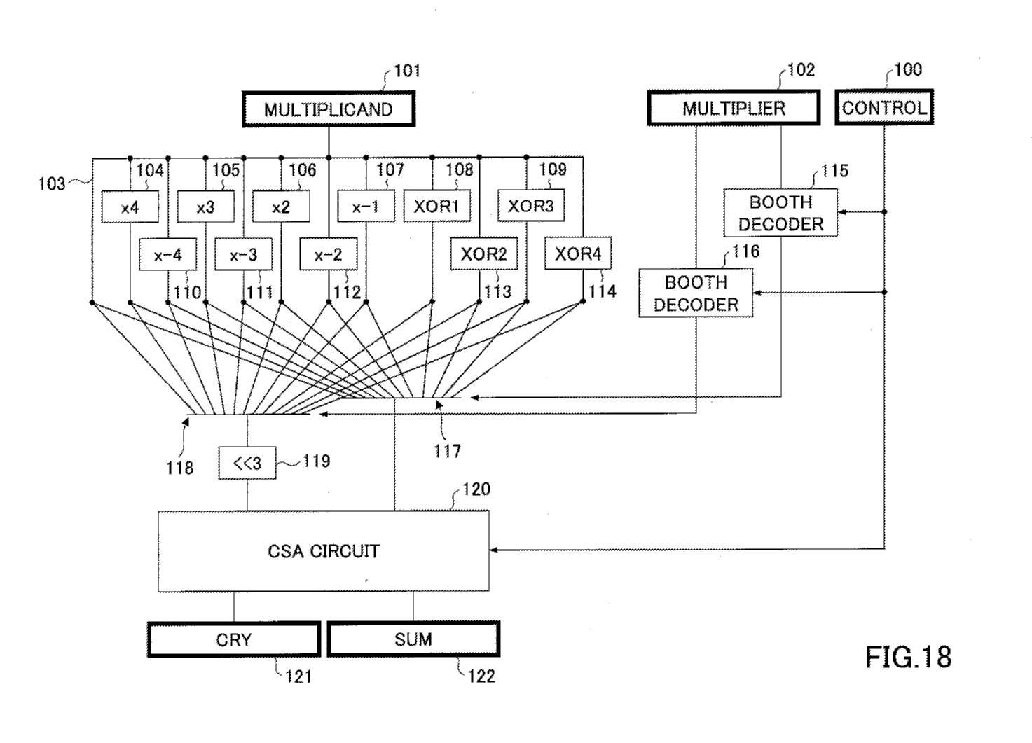

FIG. 18 is a drawing illustrating an example of an arithmetic circuit that selectively performs either normal multiplication or carry-less multiplication by processing three bits of the multiplier at a time when the multiplier has a width of 4 bits. The arithmetic circuit illustrated in FIG. 18 includes a control-value latch circuit 100, a multiplicand latch circuit 101, a multiplier latch circuit 102, a signal line 103, a fourth-multiple calculating circuit 104, a third-multiple calculating circuit 105, a second-multiple calculating circuit 106, and a negative-first-multiple calculating circuit 107. The arithmetic circuit further includes an XOR1 calculating circuit 108, an XOR3 calculating circuit 109, a negative-fourth-multiple calculating circuit 110, a negative-third-multiple calculating circuit 111, a negative-second-multiple calculating circuit 112, an XOR2 calculating circuit 113, an XOR4 calculating circuit 114, a decoder 115, and a decoder 116. The arithmetic circuit further includes a partial product selecting circuit 117, a partial product selecting circuit 118, a bit shift circuit 119, and a CSA circuit 120. Further, an addition result latch circuit 122 and a carry latch circuit 121 may be provided to store the results of an arithmetic performed by the CSA circuit 120. FIG. 1S illustrates the configuration, for a 4-bit multiplier. This is only a non-limiting example, and the bit width of the multiplier is not limited to any particular number. Irrespective of the number of bits in the multiplier, the operations of each decoder and each partial product selecting circuit are the same as or similar to the operations of the decoders and the partial product selecting circuits previously described. The wider the bit width of the multiplier is, the larger the number of bits input into the CSA circuit 120 is. Regardless of this, the fact that an XOR operation is performed in the CSA circuit 120 remains the same.

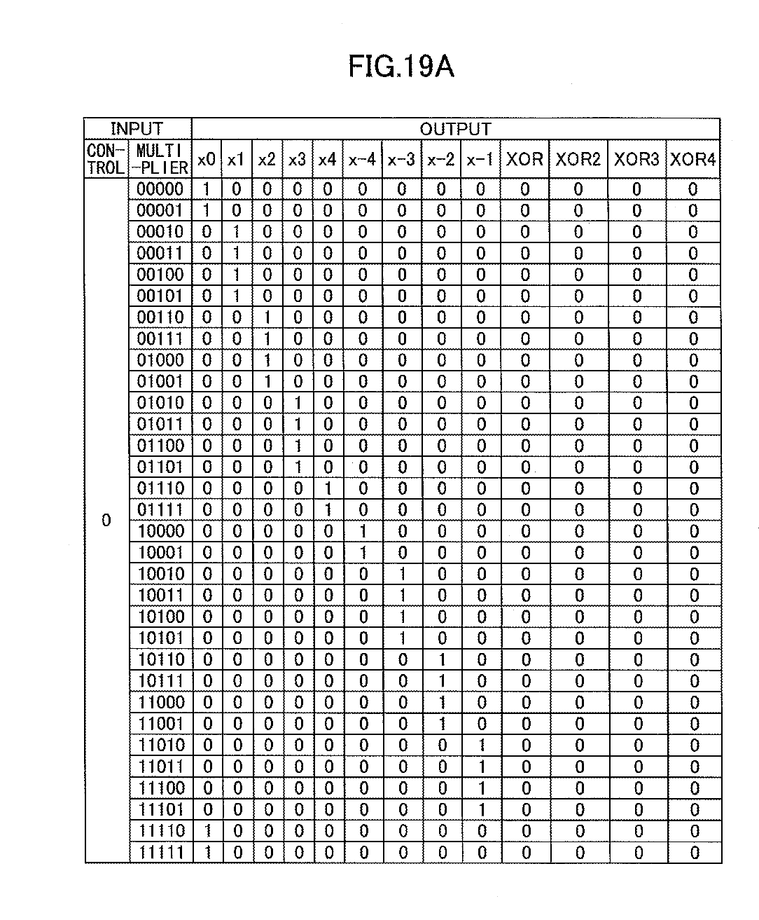

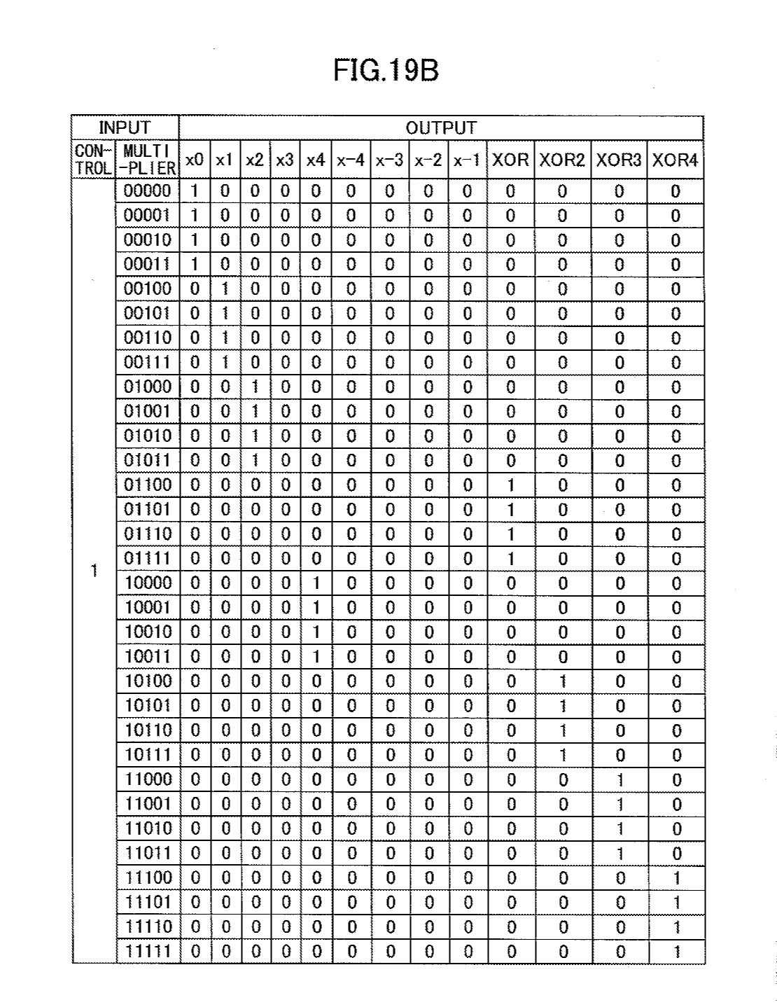

FIGS. 19A and 19B are drawings illustrating an example of the truth table that shows relationships between inputs and outputs of a decoder. Each of the Booth decoders 115 through 116 illustrated in FIG. 18 may produce a decode signal for selecting an arithmetic in accordance with the truth table illustrated in FIG. 19. When the control value stored in the control-value latch circuit 100 is “9” indicative of normal multiplication, a selection signal for selecting the third multiplicand (x3) is output in response to the five bits of the multiplier being “01011”, for example. When the control value stored in the control-value latch circuit 40 is “0” indicative of normal multiplication, a selection signal for selecting the negative of the second multiple (x−2) is output in response to the five bits of the multiplier being “11001”, for example, when the control value stored in the control-value latch circuit 110 is “1” indicative of carry-less multiplication, a selection signal for selecting the second multiple (x2) is output in response to the five bits of the multiplier being “01011”, for example. When the control value stored in the control-value latch circuit 110 is “I” indicative of carry-less multiplication, a selection signal for selecting the XOR3 operation result is output in response to the five bits of the multiplier being “11001”, for example.

While the decoders 48 through 50 of the arithmetic circuit illustrated in FIG. 9 output selection signals according to the table illustrated in FIG. 10, the decoders 115 and 116 of the arithmetic circuit illustrated in FIG. 18 output selection signals according to the table illustrated, in FIGS. 19A and 19E. Further, in the arithmetic circuit illustrated in FIG. 9, the partial product selecting circuits 51 through 53 select one of zero times the multiplicand, the first multiple, the second multiple, the negative of the second multiple, the negative of the first multiple, and the XOR1 operation result. In the arithmetic circuit illustrated in FIG. 18, on the other hand, the partial product selecting circuits 117 and 118 select one of zero times the multiplicand and the operation results illustrated in FIG. 18. Moreover, while the bit shift circuits 54 and 55 in the arithmetic circuit illustrated in FIG. 9 perform a two-bit left shift and a four-bit left shift, respectively, the bit shift circuit 119 in the arithmetic circuit illustrated in FIG. 18 performs a three-bit left shift. With respect to other than what is noted above, the arithmetic circuit illustrated in FIG. 9 and the arithmetic circuit illustrated in FIG. 18 are basically the same as or similar to each other, and a detailed description thereof will be omitted.

According to at least one embodiment, the arithmetic circuit performs carry-less multiplication at high speed.

All examples and conditional language recited herein are intended, for pedagogical purposes to aid the reader in understanding the invention and the concepts contributed by the inventor to furthering the art, and are to be construed as being without limitation to such specifically recited, examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An arithmetic circuit, comprising:
a multiplicand store circuit to store a multiplicand;
a multiplier store circuit to store a multiplier;
an n-th-multiple calculating circuit to output n-th (no integer) multiples of the multiplicand;
an intermediate XOR calculating circuit to output an XOR operation result that is a result of performing an exclusive logical sum operation between the multiplicand and a result of shifting the multiplicand to left by one bit;
a first decode circuit to output a first selection signal in response to a first portion of the stored multiplier;
a second decode circuit to output a second selection signal in response to a second portion of the stored multiplier;
a first partial product selecting circuit to select, in response to the first selection signal, one of the n-th multiples of the multiplicand output by the n-th-multiple calculating circuit and the XOR operation result output by the intermediate XOR calculating circuit;
a second partial product selecting circuit to select, in response to the second selection signal, one of the n-th multiples of the multiplicand output by the n-th-multiple calculating circuit and the XOR operation result output by the intermediate XOR calculating circuit; and
an addition circuit to output a result of adding up the first partial product selected by the first partial product selecting circuit and the second partial product selected by the second partial product selecting circuit.

2. The arithmetic circuit as claimed in claim 1, wherein the addition circuit is an XOR operation circuit provided for an overlapping portion between the first partial product and the second partial product, the XOR operation circuit configured to obtain a result of performing an exclusive logical sum operation with respect to the overlapping portion between the first partial product and the second partial product.

3. The arithmetic circuit as claimed in claim 1, wherein the addition circuit is a carry save adder circuit provided for an overlapping portion between the first partial product and the second partial product, the carry save adder circuit configured to obtain a result of performing an addition operation with respect to the overlapping portion between the first partial product and the second partial product.

4. The arithmetic circuit as claimed in claim 3, wherein the carry save adder circuit includes a mask circuit configured to block propagation of a carry that is created as a result of the addition operation performed with respect to the overlapping portion between the first partial product and the second partial product.

5. An arithmetic method, comprising:
calculating n-th (n: integer).multiples of a multiplicand;
calculating an XOR operation result that is a result of performing an exclusive logical sum operation between the multiplicand and a result of shifting the multiplicand to left by one bit;
generating a first selection signal in response to a first portion of a multiplier;
generating a second selection signal in response to a second portion of the multiplier;
selecting, in response to the first selection signal, a first partial product that is a selected, one of the n-th multiples of the multiplicand and the XOR operation result;
selecting, in response to the second selection signal, a second partial product that is a selected one of the n-th multiples of the multiplicand and the XOR operation result; and
outputting a result of adding up the first partial product and the second partial product.
